(19) United States
(12) Patent Application Publication
(10) Pub. No.: US 2016/0098635 A1
(43) Pub. Date: Apr. 7, 2016

(54) System for performing linguistic behavior analysis to detect aggressive social behavior within a specified geography

(71) Applicant: Michael Toney, Fredericksburg, VA (US)

(72) Inventor: Michael Toney, Fredericksburg, VA (US)

(21) Appl. No.: 14/580,519

(22) Filed: Dec. 23, 2014

Related U.S. Application Data
(60) Provisional application No. 62/059,898, filed on Oct. 4, 2014.

(51) Int. Cl. G06N 5/02

(52) U.S. Cl. CPC G06N 5/022

(57) ABSTRACT

An analysis system includes correlation value calculations indicating aggressive social behaviors within a specified geography performed by using computer software that quantifies keywords identified in data sources such as social media. The correlation values are calculated using a multidimensional framework, the first level of dimensions consisting of subjects such as politics, crime and terrorism, economics, and religion. Within each of the first level dimensions are sub-dimensions consisting of human behaviors such as aggression, optimism, pessimism, and pacifism. The correlation values are calculated and presented as measures of behaviors within a specified geography by using computer software to perform a proprietary algorithm.

### BACKGROUND OF THE INVENTION

1. Field of the Invention

The present invention generally relates to computer systems, such as interactive Web sites on the Internet. In particular, the invention relates to a system and method for analyzing linguistic content, and specifically to an information analysis system of analyzing multidimensional relationships between society, aggressive behaviors within a specified geography, and human expressions in data forms such as social media.

2. Background Art

The rapid global adoption of social media websites and blogs has produced billions of user-generated messages daily. While the volume of data contains information of interests to numerous entities (e.g., government, academia, and commercial marketing companies), consuming, filtering, and quantifying the data into useful information is costly and requires specialized methods.

Services exist for simple keyword filtering on limited sets of social media data; however, these services do not employ predefined keyword oriented to specific human behaviors such as aggression, optimism, pessimism, and pacifism. In addition, existing services focus primarily on reputation management and marketing of a company, product, brand or person as opposed to creating information useful for national defense-related operations.

Linguistic content analysis is well known within linguistics communities; however, it has not been used for behavior analysis of a specified geography using the quantification of human expression in very large data volumes; rather, it is typically used for analyzing the behaviors of a single individual such as in the analysis of presidential speeches. Linguistic content analysis is also typically built upon a one-dimensional framework.

A need exists in the current art for a method of performing linguistic content analysis with no geographical limitations (user specified) using human expression data such as social media, more specifically, to detect human behaviors that threaten societal stability and the ability of governments to sustain public safety during times of political, crime or terrorism, religious, or economic crisis. Furthermore, this need exists not for statisticians and behavior professional, but for end-users responsible for other aspects of society such as emergency management and national security.

The present invention provides correlation value calculations indicating geographically organized behaviors, as a method, encoded in computer software that quantifies keywords identified in data such as social media. From these values, human behaviors are evaluated and presented in geographical and temporal context without being affected by the coincidental cause.

### SUMMARY OF THE INVENTION

The present invention relates to an analysis system of performing correlation value calculations indicating behaviors within a specified geography by using computer software on a digital computer to quantify keywords identified in selected data sources. The computer software performs an analysis over a group of geographically defined individuals such as those within a nation state, regional area, or local community. The computer software consumes volumes of data from sources such as social media and segments the data by geography (where the message was generated), and time (when the message was generated).

Data are collected from selected data sources and filtered based on keywords segmented into dimensions such as politics, crime and terrorism, economies, and religion. These dimensions represent specific subject areas of public sentiment (human expression). The data is quantified and standardized to be stored In a database structure on a computer.

In one embodiment of the present invention, a translation unit modifies a body of software to use unique variant languages in order to translate foreign linguistic content to the standard language implemented by a standard system component. An interception of re-translation service requests limits usage of the service to computer software that has been pre-translated so use unique variant languages.

The present invention uses an algorithm technique performed by using computer software to calculate behavior related words in additional sub-dimensions using behavior classifications such as aggression, optimism, pessimism, and pacifism. The final calculated values are stored in a database structure on a computer from which queries produce data for easily visualizing human behavior over time and geography. End users can manipulate and analyze the data using web-based gauges and maps.

The analysis results are output, such as by being displayed over the internet using a web browser, or on any device that supports web browsers and internet connectivity, wherein selected individuals and sub-groups of individuals may be highlighted, and wherein behavior classifications may be indicated. Analysis results may also be output as graphic slider bars.

In the present invention, a description representing a noun, a topic, an opinion, and an event in a text as well as a word including a keyword is referred to as linguistic content. The linguistic content may be a character string itself that appears in a text or a result obtained by analyzing a text by using an existing natural language processing technique such as syntactic analysis, dependency analysis, or synonym processing.

### BRIEF DESCRIPTION OF DRAWINGS

FIG. 1 is a flow diagram illustrating a process flow in a linguistic behavior analysis method according to the preferred embodiment of the present invention.

FIG. 2 is a block diagram illustrating a distributed network environment according to the preferred embodiment of the present invention.

FIG. 3 is a flow diagram of a client interface method for collecting message software according to the preferred embodiment of the present invention.

FIG. 4 is a block diagram of a computer device used for the preferred embodiment of the present invention.

### DETAILED DESCRIPTION OF THE INVENTION

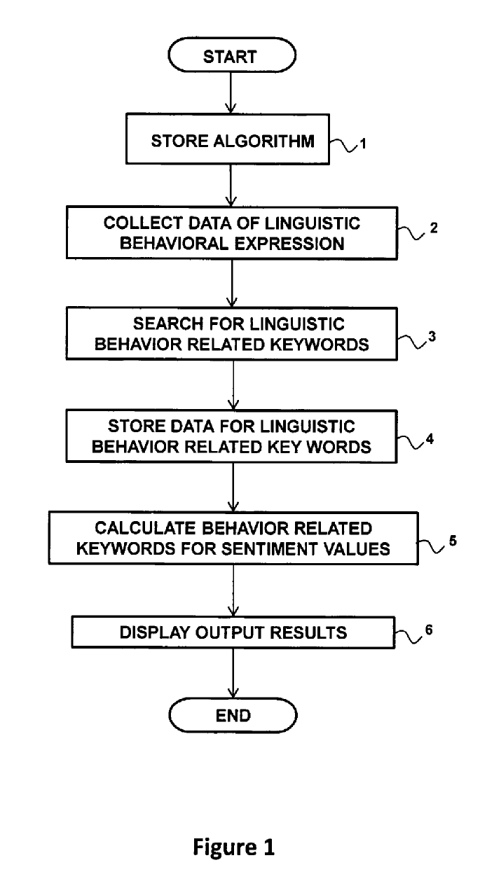

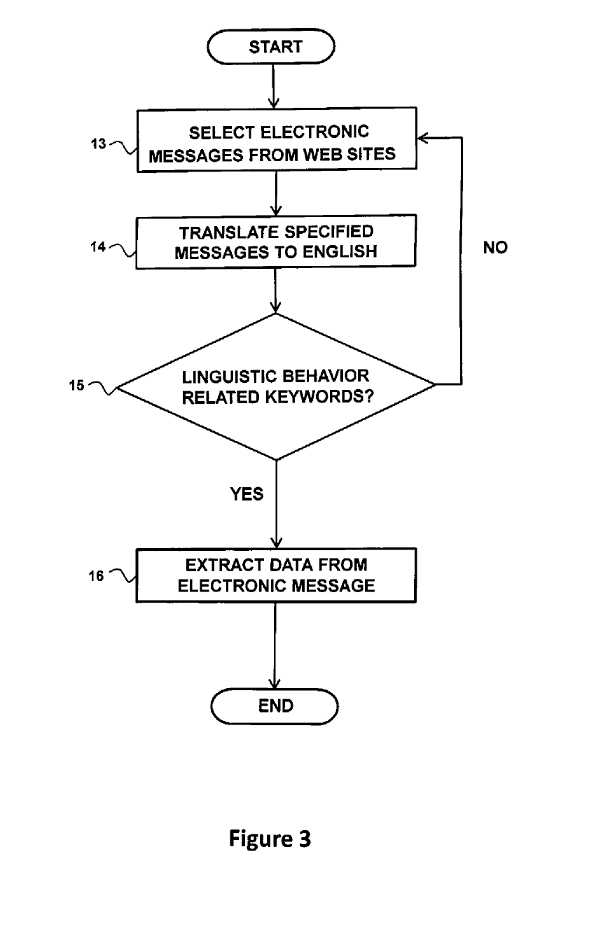

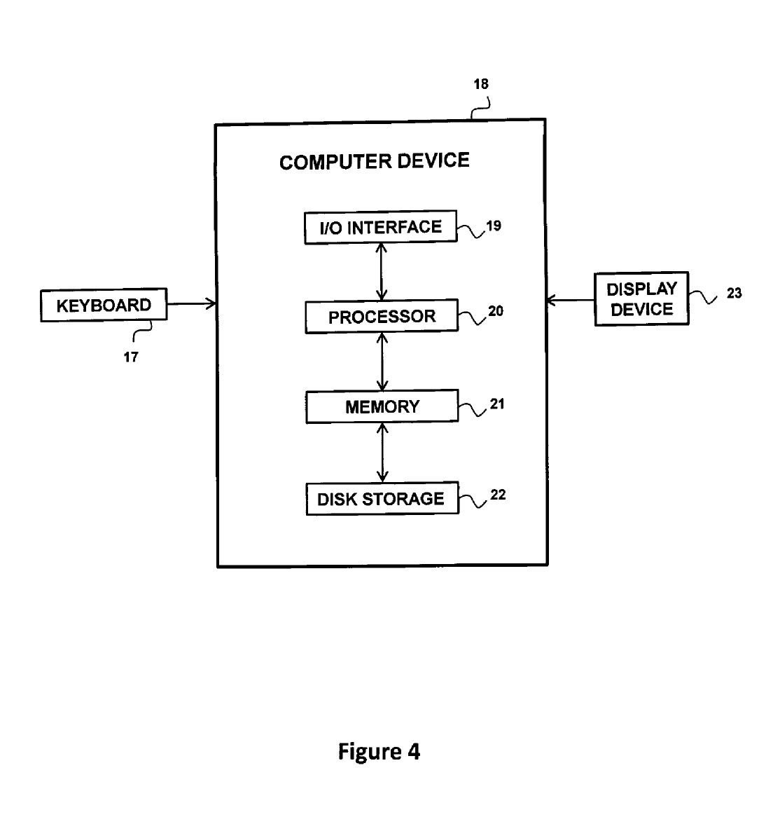

FIG. 1 to FIG. 4 describes an embodiment of the present invention comprising a linguistic behavior analysis system, a linguistic behavior analysis method, and a computer software program. A configuration of the linguistic behavior analysis system according to the embodiment of the present invention will be described with reference to FIG. 1. A diagram illustrating how a linguistic behavior analysis system implemented over a distributed network is illustrated in FIG. 1. A flow diagram illustrating link information data generated according to the embodiment of the present invention is described in FIG. 3. Finally, a block diagram illustrating a computer device to perform data processing for the preferred embodiment of the present invention is shown in FIG. 4.

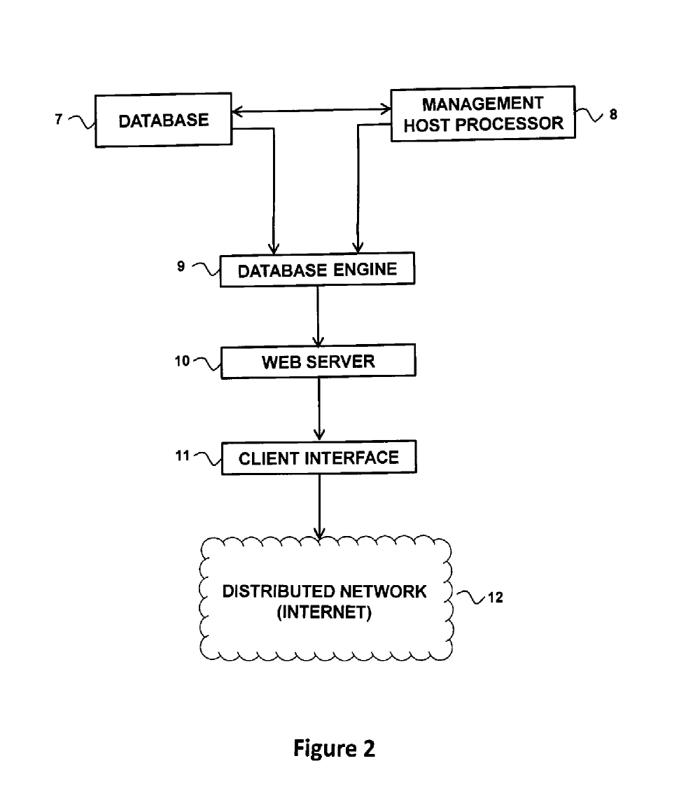

Referring the linguistic behavior analysis system illustrated in FIG. 1, and with reference to the linguistic behavior analysis system in FIG. 2, is a method that has a plurality of linguistic behavior related messages as an analysis target and is used to analyze correlativity between one linguistic behavior related messages and specific human behaviors for public sentiments. As illustrated in FIG. 1, the present method begins with step 1, wherein an algorithm technique for calculation of behavior related keywords performed by using computer software is stored in database 7 referred in FIG. 2.

FIG. 1 shows step 2 of the present method, wherein a user makes a determination to select electronic messages from Web sites on the Internet and social media by using client interface referred in FIG. 3. Once the user determines that the electronic messages contain data of linguistic behavior expression in step 1, the method proceeds step 3.

FIG. 1 shows step 3, wherein the data collected from the client interface is processed for the search of linguistic behavior related keywords. Based on the geographic information and the relationship between the electronic messages, the client interface detects correlativity between one linguistic behavior related messages and specific human behaviors for public sentiments.

Referring FIG. 1, at step 4, the data indicative of linguistic behavior related keywords from the step 3 is first extracted in each of a plurality of electronic messages including at least anyone of a plurality of linguistic behavior related keywords and transmitted, via a distributed network, to store in a database server, wherein the data will be uploaded to database 7.

FIG. 1 further shows step 5, wherein the management host processor 8 is operable to perform a correlation value calculation which calculates the behavior related keywords for public sentiment values between linguistic behavior expressions.

Still referring FIG. 1, at step 6, the output data as generated in step 5 is displayed over the internet using a web browser, or any device that supports web browsers and internet connectivity.

FIG. 2 illustrates a block diagram according to one preferred embodiment of the invention wherein the linguistic behavior analysis system is implemented over a distributed computer network. While in the preferred embodiment the network is the Internet, the invention is equally applicable to any distributed network, whether public or private.

In FIG. 2, a database 7 contains information relating to the linguistic behavior expression data obtained from Web sites on the Internet, which is associated with aggressive social behavior activities. A management host processor 8 communicates with the database 7 and with a database engine 9. Management host processor 8 performs administrative and management functions in maintaining the database 7, process the data algorithm, and producing output the data. The database engine 9 is in communication with a web server 10 that is part of a distributed network 12, such as the Internet, and in particular the World Wide Web. A client interface 11 is also part of the distributed network. The client interface 11 may be implemented as part of the web server 10, including web browser software enabling the client interface 11 to communicate with and receive and process data from the web server 10.

As shown in FIG. 2, the database 7 is preferably a Relational Data Base Management System (RDBMS), as well known in the art. The database engine 9 is preferably implemented via CGI through the web server 10. The database 7 may communicate with the database engine 9 and the management host processor 8 through conventional Open Data Base Connectivity (ODBC) protocol, while the management host processor 8 may communicate with the database engine 9 through TCP/IP (Transmission Control Protocol/Internet Protocol) protocol.

Still referring to FIG. 2, the database 7 stores a plurality of information relating to linguistic behavior expressions that is processed by the database engine 9 during live, interactive sessions with client interface 11. The database 7 includes user electronic message profiles, historical data, behavior analysis rules and logic data, aggression model behavior data, and measurement output data.

FIG. 3 is a flow diagram showing a client interface method for data collection computer software according to the present invention. Data collected from Web sites on the Internet, social media or related services include an arrangement of relatively simple text messages in users' specific languages. The following method is described with reference to collection and selection of relevant data information for linguistic behavior analysis.

Referring to FIG. 3, process block 13 indicates that a selection of electronic messages for each of the plurality of interactive Web site on the Internet being associated with particular dimensional intensities of aggressive social behaviors is rendered on display screen. In a preferred embodiment, each selected data segment represents a specific subject area of public sentiment.

As illustrating in FIG. 3, process block 14 indicates that a selected electronic message that is foreign linguistic content is translated to English standard language. The English translated electronic messages in the process block 14 continue to proceed to decision block 15 to search for linguistic behavior related keywords. The decision block 15 represents an inquiry as to whether a user select relevant linguistic behavior related keywords from the selected electronic messages. If the user does not find relevant linguistic behavior related keywords, decision block 15 returns to process block 13 for another electronic messages; otherwise, the decision block 15 proceeds to process block 16.

FIG. 4 shows an operating system environment for the preferred embodiment of the present invention is a computer device 18 that comprises at least one high speed processor 20, in conjunction with a memory system 21, at least one high capacity disk storage 22, an input device 17, and an output device 23. The input device 17 and output device 23 are interconnected by an I/O interfaced.

Referring FIG. 4, the illustrated processor 20 is of familiar design for performing computations, a collection of memory 21 for temporary storage of data and instructions, and disk storage 22 for storing data. Processor 20 may have any of a variety of architectures including Alpha from Digital, MIPS from MIPS Technology, NEC, IDT, Siemens, and others, x86 from Intel and others, including Cyrix, AMD, and Nexgen, and the PowerPC from IBM and Motorola.

In FIG. 4, the memory 21 takes a form of 8 or 16 gegabytes of semiconductor RAM memory. Disk storage 22 takes a form of long term storage, such as ROM, optical or magnetic disks, flash memory, or tape. Those skilled in the art will know of alternative components.

Still referring FIG. 4, the input and output devices 17, 23 are also familiar. The input device 17 can comprise a keyboard and a mouse. The output device 23 can comprise a display monitor or a printer. Some devices, such as a network interface or modem, can be used as input and/or output devices.

As is familiar to those skilled in the art, the computer device 18 further includes an operating system and at least one application program. The operating system is the set of software which controls the computer system's operation and the allocation of resources. The application program, such as one implementing the present invention, is the set of software that performs a task desired by the user and makes use of computer resources made available through the operating system. Both are resident in the illustrated memory 21.

In accordance with the practices of persons skilled in the art of computer programming, the present invention is described below with reference to symbolic representations of operations that are performed by computer device 18, unless indicated otherwise. Such operations are sometimes referred to as being computer-executed. It will be appreciated that the operations which are symbolically represented include the manipulation by the processor 20 of electrical signals representing data bits and the maintenance of data bits at memory locations in the memory 21, as well as other processing of signals. The memory locations, where data bits are maintained, are physical locations that have particular electrical, magnetic, or optical properties corresponding to the data bits.

Having illustrated and described the principles of the present invention in a preferred embodiment, it will be apparent to those skilled in the art that the embodiment can be modified in arrangement and detail without departing from such principles. Any and all such embodiments are intended to be included within the scope of the following claims.

What is claimed is;

1. A computer-implemented system for analyzing linguistic behavior expression for aggressive social behaviors, comprising:
(a) interface means for enabling a user to collect data relating to linguistic behavior expressions which indicates aggressive social behaviors;
(b) a database operatively connected to said interface means and operable to receive and store said data;
(c) a database engine which utilizes said linguistic behavior data to analyze human aggressive behaviors and generate results according to a behavior algorithm.

2. The system of claim 1 wherein said interlace means further comprising a search engine operable to select linguistic behavior related keywords;

3. The system of claim 1, therein said interface means further comprising means for extracting said data for uploading to said database;

4. The system of claim 1, therein said interlace means further comprising, means for uploading said data, via a distributed network, to said database;

5. The system of claim 1 wherein said database stores said behavior algorithm to calculate said linguistic behavior related keywords for dimensional intensities.

6. The system of claim 1, wherein said database stores linguistic behavior expression data for a plurality of interactive Web sites on the Internet, each Web she being associated with particular dimensional Intensities of aggressive social behavior activities.

7. The system of claim 1 wherein said database engine outputs textual dialogue indicative of aggressive social behaviors.

8. The system of claim 1, wherein said system is implemented on a distributed network.

9. The system of claim 8, wherein said distributed network is the internet, and said interface means comprises a Web browser.

10. A computer-implemented method for analyzing linguistic behavior expressions for aggressive social behaviors to be executed by a processor in a computer, comprising the steps of:
a) storing a behavior algorithm for calculating linguistic behavior related keywords for dimensional intensities;
(b) collecting data from at least any one of the plurality of electronic messages Including at least any one of the plurality of linguistic behavior expressions;
(c) searching said data for linguistic behavior related keywords;
(d) storing said data to a database; and
(e) processing said data of relevant linguistic behavior related keywords according to said algorithm for public sentiment values.

11. The method of claim 10, wherein said linguistic behavior expressions include indication of human aggressively behavior state.

12. The method of claim 10, wherein the step of collecting data further comprising the step of selecting at least one of the plurality of interactive Web sites on the Internet, each Web site being associated with particular dimensional intensities of aggressive social behaviors.

13. The method of claim 12, wherein the step of collecting data further comprising the step of translating data into English.

14. The method of claim 10, wherein the step of storing data further comprising the step of extracting said data for uploading to said database;

15. The method of claim 10, the step of storing data further comprising the step of uploading said data to said database for a plurality of different segmented messages, each segmented message being associated with particular dimensional intensities of aggressive social behavior activities.

16. The method of claim 10, the step of processing data further comprising the step of calculating behavior related keywords indicative of aggressive social behaviors.

17. The method of claim 10, the step of processing data further comprising the step of outputting textual dialogue indicative of aggressive social behaviors.

18. The method of claim 10, wherein the method is implemented on a distributed network.

19. The method of claim 17, wherein said distributed network is the Internet, and said linguistic behavior expression data is received by a Web browser.

20. A computer program product having a computer readable medium having computer readable code recorded thereon for analyzing linguistic behavior expressions for aggressive social behaviors comprising:
(a) means for storing a behavior algorithm calculating linguistic behavior related keywords for dimensional intensities;
(b) means for collecting data from at least any one of the plurality of electronic messages including at least any one of the plurality of linguistic behavior expressions;
(c) means for searching said data for said linguistic behavior related keywords;
(d) means for storing said data to a database;
(e) means for processing said data according to said algorithm for public sentiment values; and
(f) means for displaying analysis results.
